(19) United States
(12) Patent Application Publication
(10) Pub. No.: US 2024/0374069 A1
(43) Pub. Date: Nov. 14, 2024

(54) DEVICE FOR DRAWING JUICE FROM A JUICE CONTAINER OF A FRUIT PRESS

(71) Applicant: Citrocasa GmbH, Linz (AT)

(72) Inventor: Johannes Huber, Luftenberg (AT)

(73) Assignee: Citrocasa GmbH, Linz (AT)

(21) Appl. No.: 18/555,026

(22) PCT Filed: Sep. 28, 2022
(86) PCT No.: PCT/AT2022/060337

§ 371 Date: Oct. 12, 2023

(30) Foreign Application Priority Data
Dec. 14, 2021 (AT) A 50999/2021

(51) Int. Cl. A47J 19/02

(52) U.S. Cl. CPC A47J 19/02

(57) ABSTRACT

A device for drawing juice from a juice container of a fruit press includes an outlet which is connected to the juice container, has a removal valve and is located above a vessel receptacle. In order to provide advantageous structural conditions, the vessel receptacle forms a holder which receives a hanging bottle by the neck thereof, is supported on at least one weighing cell and is assigned at least one filling level sensor. The removal valve can be activated by a control device, which is connected to an input unit, depending on the measurement signals of the weighing cell and of the filling level sensor.

### TECHNICAL FIELD

The system described herein relates to a device for drawing juice from a juice container of a fruit press.

### BACKGROUND

Fruit presses, especially for citrus fruits, often have spherical pressing punches that engage in hemispherical dies and squeeze out the halved fruits picked up by the dies. The squeezed, collected juice is discharged through an outlet and can be collected in a vessel. To enable juice to be extracted independently of the pressing process, a juice container is provided which receives the squeezed juice and is provided with an outlet and a drawing valve, usually in the form of a tap, arranged in the course of the outlet. Since the distance between the vessel mounting, which is formed by an installation surface for a vessel, and the tap is predetermined by design, the tap conditions depend on the size of the vessels to be filled. This circumstance prevents the filling of vessels of different sizes, in particular bottles, under constant filling conditions, in order to be able to largely exclude contamination of the vessels or the vessel mounting by misdirected juice flows.

### SUMMARY OF THE INVENTION

The system described herein is thus based on the task of creating constructive prerequisites in order to be able to fill bottles advantageously from the juice container of a fruit press under constant filling conditions without having to accept the risk of contamination of the bottles or the vessel mounting by misdirected juice flows.

Starting from a device of the type described above, the system described herein solves the set task in that the vessel mounting forms a holder receiving a hanging bottle on the neck side and being supported on at least one weighing cell and to which holder at least one filling level sensor is assigned, and in that the drawing valve can be controlled—as a function of the measurement signals from the weighing cell and the filling level sensor—by a control device connected to an input unit.

Since the bottles to be filled, which usually have a thread for a screw cap, which thread is delimited by a protruding collar relative to the neck, or a thickened cap receptacle, are positioned hanging on the neck side in a holder of the vessel mounting and therefore the holder structurally determines the distance of the filling opening of the bottles from the outlet of the juice container regardless of the bottle size, consistent filling conditions can be ensured for all bottle sizes.

In order to monitor the filling of the bottles using measurement signals, the holder of the vessel mounting is supported on at least one weighing cell so that the respective filling volume can be determined on the basis of the weight measurement. The density of the squeezed fruit juice can be specified with sufficient accuracy for this purpose.

In addition, the filling process is monitored by at least one filling level sensor which is assigned to the holder of the vessel mounting. This fill level sensor, which can be designed as a capacitive distance sensor, for example, can be used to detect the remaining fill level above the already filled juice volume that is still available for the filling process, irrespective of the bottle size, and thus reliably prevent overfilling of the bottle.

To operate the drawing valve, the drawing valve is connected to a control device which is connected to an input unit and is supplied with the measurement signals of the weighing cell and the filling level sensor. The input unit can thus be used to preselect the desired filling volume in order to initiate the filling process. With the aid of the weighing cell, the presence of a bottle in the holder of the vessel mounting can be checked by the control device and then the filling process initiated, which is terminated when the weighing cell indicates the target weight entered via the input unit. If the bottle held in the holder on the neck side has a holding volume that is too small for the preselected filling volume, i.e., there is a risk of overfilling, the filling process is interrupted on the basis of the measurement signals of the filling level sensor as soon as a predefined maximum filling level is indicated.

Although various holders are possible for the neck-side reception of hanging bottles, for example in the form of grippers enclosing the bottle neck below a screw thread for a screw cap in a pincer-like manner, particularly simple design conditions result when the holder forms a fork for hanging a bottle on the neck side.

The drawing valve and an actuator of the drawing valve can also be designed differently, because according to the system described herein it is primarily a matter of a corresponding control of the drawing valve. Nevertheless, an advantageous design can be ensured by the outlet having a downpipe socket and an outlet socket telescopically displaceable on the downpipe socket, by the drawing valve including a valve seat formed at the outlet-side of the downpipe socket and a valve body cooperating with this valve seat and held in a displacement-proof manner in the outlet socket, and by the outlet socket, which is spring-loaded in the closing direction of the drawing valve, being displaceable by an actuator counter to the spring loading. Since, as a result of these measures, the outlet socket, which is telescopically displaceable on the downpipe socket, serves as an actuator for the drawing valve, the outlet socket is lowered against the filling opening of the bottle to be filled in order to open the drawing valve, so that the fruit juice flowing out of the outlet socket flows directly into the filling opening of the bottle held in the holder. The drawing valve is designed for this purpose because the valve body, which is held in the outlet socket in a displacement-proof manner, interacts with the valve seat formed at the outlet end of the downpipe socket and is spring-loaded in the closing direction, so that the outlet socket must be moved against the spring load in order to open the drawing valve, which can be achieved in a simple manner using an actuator.

The intended design of the drawing valve creates simple conditions for automatic operation of the device when the actuator is controlled by a control device connected to the input unit. Electromagnetic actuators are particularly suitable for this, but are by no means mandatory.

### BRIEF DESCRIPTION OF DRAWINGS

In the drawing, the object of the system described herein is shown by way of example, where

FIG. 1 a simplified side view of a device according to the system described herein for drawing juice from a juice container of a fruit press,

FIG. 2 is a view of the device in a section parallel to the side view along the outlet in the closed position of the drawing valve and

FIG. 3 is a section corresponding to FIG. 2, but with the drawing valve open.

### DETAILED DESCRIPTION OF VARIOUS EMBODIMENTS

The device shown, which forms part of a fruit press, includes a juice container 1, the bottom 2 of which is provided with an outlet 3. This outlet 3 has a downpipe socket 4 and an outlet socket 5 which is telescopically displaceable on the downpipe socket 4. Although in the illustrated embodiment example the downpipe socket 4 is attached to the bottom 2 of the juice container 1, this is not mandatory. For reasons of space, the downpipe socket 4 can, for example, also be connected to an outflow pipe which starts from a wall of the juice container 1 in a bottom area of the juice container 1.

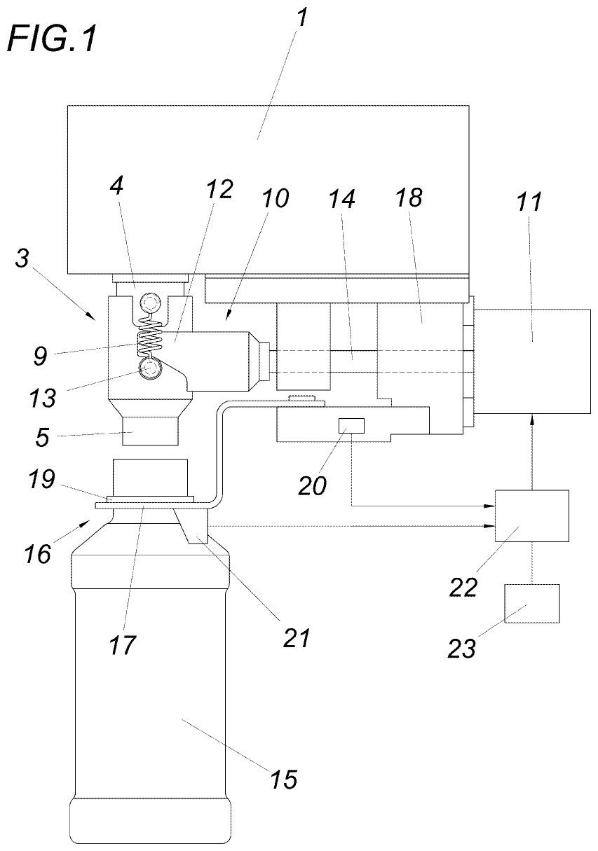

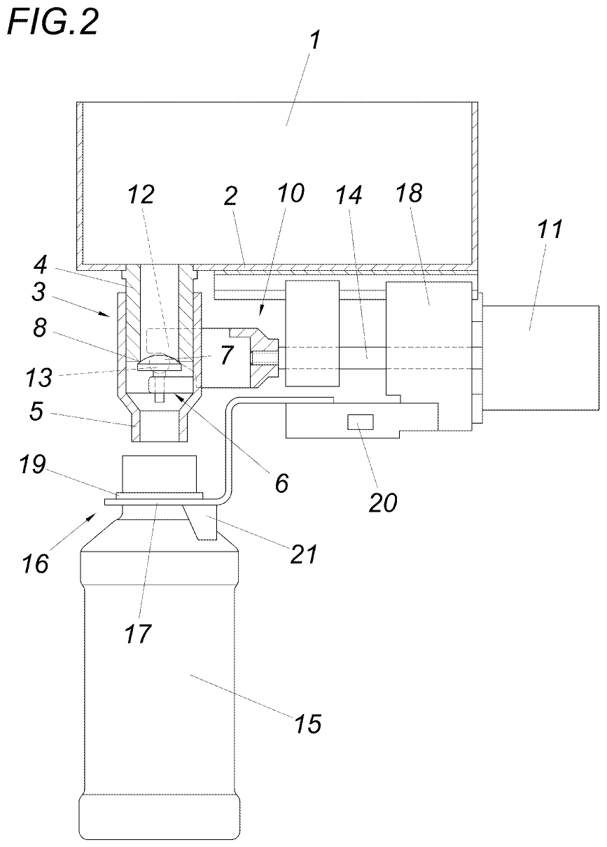

In the outlet 3 a drawing valve 6 is provided formed by a valve body 7 coaxial with the downpipe socket 4 and a valve seat 8 formed at the end of the downpipe socket 4. Since the valve body 7 is held in the outlet socket 5 in such a way that the valve body 7 cannot move, the outlet socket 5, which can be moved telescopically on the downpipe socket, serves as an actuator for the valve body 7, which actuator is spring-loaded in the closing direction of the drawing valve 6, so that the drawing valve 6 takes a spring-loaded closed position as shown in FIG. 2. The spring loading of the outlet socket 5 is achieved according to FIG. 1 by two diametrically opposed coil springs 9, which act on the one hand on the downpipe socket 4 and on the other hand on the outlet socket 5.

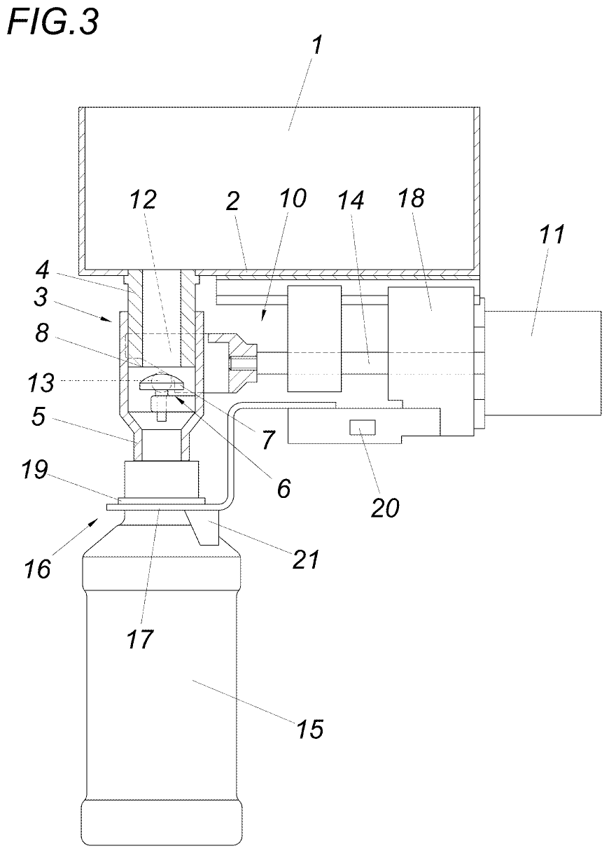

To open the drawing valve 6, the outlet socket 5 is displaced using an actuator 10 against the force of the coil springs 9 downwards along the downpipe socket 4 into the open position as shown in FIG. 3. The actuator 10 is advantageously designed as a wedge gear connected to an electromagnetic drive 11, which wedge gear includes a driving wedge 12 with two arms engaging around the outlet socket 5 and two run-up rollers 13 cooperating with the driving wedge 12 on opposite sides of the outlet socket 5. The driving wedge 12 is connected to the electromagnetic drive 11 by an axially displaceable drive rod 14, which electromagnetic drive advantageously has an electric coil with an iron core as a linear drive. Accordingly, when the electromagnetic drive 11 is actuated, the two arms of the driving wedge 12 are moved against the run-up rollers 13 of the outlet socket 4 with the effect that the run-up rollers 13 running along the wedge-shaped arms of the driving wedge 12 move the outlet socket 5 downwards against the force of the coil springs 9 on the downpipe socket 4, so that the valve body 7 is lifted off the valve seat 8. Although such a drawing valve 6 with the actuator 10 represents an advantageous design variant, the invention is not limited to such a constructive design, because it is not the type of drawing valve and its drive that is important, but rather the hanging position of the bottles 15 to be filled in a vessel mounting 16 and the monitoring of the filling process in this hanging bottle position.

The vessel mounting 16 has a holder 17 for suspended bottle mounting, for example in the form of a fork. This holder 17 is provided below the outlet 3 on a frame 18 which also accommodates the juice container 1 with the outlet 3 and the actuator 10 for the outlet socket 5. The holder 17 engages under the collar 19 of the bottle 15 to be filled, which collar normally serves as the threaded end of the bottle neck, so that the bottle 15 only has to be hooked into the fork of the holder 17 on the neck side and is held at a structurally predetermined distance from the outlet 3. This distance is preferably selected as a function of the opening path of the drawing valve 6 in order to be able to use the opening movement of the outlet socket 5 to lower the outlet end of the outlet socket 5 into the region of the filling opening of the bottle 15.

For monitoring the filling process, the holder 17 of the vessel mounting 16 is supported by at least one weighing cell 20 in a load-bearing manner relative to the frame 18. In addition, at least one filling level sensor 21 is assigned to the holder 17, which filling level sensor 21 detects the respective distance of the liquid level to the holder 17. Via the weighing cell 20 and the filling level sensor 21, a control device 22, schematically indicated in FIG. 1, is supplied with corresponding measurement signals in order to control the electromagnetic drive 11 of the actuator 10 in accordance with the measurement signals evaluated as a result of the program. With the aid of an input unit 23, additional parameters influencing the control of the electromagnetic drive 11 can be specified to the control device 22.

1. A device for drawing juice from a juice container of a fruit press, comprising:
an outlet connected to the juice container and having a drawing valve; and
a vessel mounting disposed below the outlet and forming a holder that receives a hanging bottle at a neck side thereof and being supported on at least one weighing cell, the holder having at least one filling level sensor is assigned thereto, wherein the drawing valve is controlled as a function of the measurement signals of the weighing cell and of the filling level sensor by a control device connected to an input unit.

2. The device according to claim 1, wherein the holder forms a fork for hanging a bottle on a neck side thereof.

3. The device according to claim 1, wherein the outlet has a downpipe socket and has an outlet socket which is telescopically displaceable on the downpipe socket, in that and wherein the drawing valve includes a valve seat formed at an outlet-side end of the downpipe socket and a valve body, which cooperates with the valve seat and is held in a displacement-proof manner in the outlet socket and wherein the outlet socket is spring-loaded in a closing direction of the drawing valve and is displaceable counter to the spring loading by an actuator.

4. The device according to claim, wherein the outlet has a downpipe socket and has an outlet socket which is telescopically displaceable on the downpipe socket and wherein the drawing valve includes a valve seat formed at an outlet-side end of the downpipe socket and a valve body, which cooperates with the valve seat and is held in a displacement-proof manner in the outlet socket and wherein the outlet socket is spring-loaded in a closing direction of the drawing valve and is displaceable counter to the spring loading by an actuator.
